(19) United States
(12) Patent Application Publication
(10) Pub. No.: US 2024/0027263 A1
(43) Pub. Date: Jan. 25, 2024

(54) DEVICE FOR CHARACTERIZING FLICKER

(71) Applicant: ams International AG, Jona (CH)

(72) Inventors: Ravi Kumar ADUSUMALLI, AE Eindhoven (NL); Rahul THOTTATHIL, AE Eindhoven (NL); Gowri Krishna Kanth AVALUR, AE Eindhoven (NL); Sudhakar SINGAMALA, AE Eindhoven (NL); Dinesh KURUGANTI, AE Eindhoven (NL); Vijay ELE, AE Eindhoven (NL)

(21) Appl. No.: 18/267,062

(22) PCT Filed: Dec. 8, 2021
(86) PCT No.: PCT/EP2021/084871

§ 371 Date: Jun. 13, 2023

(30) Foreign Application Priority Data
Dec. 14, 2020 (GB) 2019668.9

(51) Int. Cl. G01J 1/44

(52) U.S. Cl. CPC G01J 1/44; G01J 2001/4247

(57) ABSTRACT

An optical device for characterizing flicker from an ambient light source is disclosed. The device comprises a radiation-sensitive device configured to vary a current in response to incident radiation, a second or higher-order modulator configured to output data corresponding to the current, and processing circuitry configured to provide a real-time characterization of flicker in the incident radiation based upon an analysis of changes in the data. Also disclosed is an associated method of characterizing flicker from an ambient light source.

### TECHNICAL FIELD OF THE DISCLOSURE

The present disclosure is in the field of ambient light sensing, and particularly relates to characterization of flicker from an ambient light source.

### BACKGROUND

Changes in a brightness of a light source due to, for example, fluctuations in a voltage of a power supply to the light source, may be generally known in the art as flicker. Whether a human eye can perceive flicker of a light source may depend upon characteristics of the flicker such as amplitude of the flicker and, in particular, upon a frequency of the flicker.

Light sources, such as incandescent lights, fluorescent lights and Light Emitting Diodes (LEDs) may produce flicker. Such light sources often provide, or at least contribute to, ambient light in a scene. Flicker from such light sources may be due to inherent features of the light source itself, or to the power supply or driver for the light source.

For example, it is known that a flicker of 50 Hz or 60 Hz may be generated in household light sources due to the frequency of the alternating current in the power supply. The particular frequency of the flicker may depend upon a geographical location of the household, e.g. US domestic power supplies are known to operate at 60 Hz AC whereas European domestic power supplies operate at 50 Hz AC. Similarly, LED lighting flicker characteristics may be primarily a function of associated LED driver circuitry.

A capability of image capture devices, such as cameras, to capture images may be affected by the effects of flicker in an ambient light source. For example, image sensors wherein an exposure time of the sensors is not synchronized to, or correlated with, a frequency of ambient flicker may provide images affected by the flicker.

In particular, image sensors operating in a rolling shutter mode, wherein different rows of pixels have different exposure times such that different lines of the image are captured at slightly different points in time, may be particularly prone to capturing images exhibiting the effects of flicker.

Such effects may be manifested as lines in photos or as rolling lines in videos, and are known in the art as ‘banding’.

Image capture devices are not always capable of detecting flicker in an image, or meaningfully compensating for or avoiding such flicker. Known solutions to mitigate the effects of flicker in digital cameras include configuring the camera based upon geographical location, such that pre-existing information pertaining to likely flicker frequencies may be used to configure exposure times of the camera. For example, a camera in the US may be configured to avoid the effects of flicker due to a 60 Hz AC power supplies, whereas the camera in Europe may be configured to avoid the effects of flicker due to 50 Hz AC power supplies. Such solutions are rudimentary, costly, may require manual configuration, and are specific to known mains power supplies and not to a wider range of possible artificial ambient light sources.

Other solutions may require post-processing images to remove the effects of flicker. Such processing may be computationally intensive, and relatively costly to implement in terms of software-overhead and related processing requirements.

Further solutions may require capture of multiple images such that effects of flicker may be compensated for using information taken from across a plurality of images. Such solutions may also be relatively slow and computationally intensive.

It is therefore desirable to provide and low-cost and low-complexity, yet highly effective means for image capturing devices to avoid or mitigate the effects of flicker from an ambient light source. It is also desirable that any such means is effective under various different ambient lighting conditions, and does not incur significant delays in providing images, or substantially impact the quality of captured images.

It is therefore an aim of at least one embodiment of at least one aspect of the present disclosure to obviate or at least mitigate at least one of the above identified shortcomings of the prior art.

### SUMMARY

The present disclosure is in the field of ambient light sensing, and particularly relates to characterization of flicker from an ambient light source.

According to a first aspect of the disclosure, there is provided an optical device for characterizing flicker from an ambient light source. The device comprises a radiation-sensitive device configured to vary a current in response to incident radiation, a second or higher-order modulator configured to output data corresponding to the current, and processing circuitry configured to provide a real-time characterization of flicker in the incident radiation based upon an analysis of changes in the data.

Advantageously, such a device enables a relatively low-cost and low-complexity, yet highly effective real-time characterization of flicker from an ambient light source. Furthermore, by implementing such a direct analysis of output data from the modulator to determine characteristics of the flicker, no significant delays are incurred in characterizing the flicker as would be the case in prior art solutions, which may otherwise implement substantial software-based image post-processing. Furthermore, with such a solution, it would not be necessary to capture a plurality of images to retrospectively compensate for the effects of flicker, as is also the case in some prior art solutions.

Advantageously, such a device may not require implementation of additional narrow-band optical channels specifically designed to filter radiation from light sources known to provide flicker. For example, some optical devices implement channels, such as mercury-high (Hg-h) and mercury-low (Hg-I) channels suitable for detection of radiation emitted by mercury-vapor lamps. Such narrow-band detection of radiation may enable subsequent compensation for the effects of flicker. However, such additional channels are costly, and may have limited accuracy due to optical properties and manufacturing limitations of the optical filters associated with the channels. Such issues are circumvented by the presently disclosed device, wherein flicker is more readily characterized by effectively extracting characterizing of the flicker from the ambient radiation using the second or higher-order modulator.

Advantageously, implementation of the second or higher-order modulator enables accurate and fast generation of a digital signal corresponding to radiation from the radiation-sensitive device, wherein the processing circuitry directly provides a real-time characterization of flicker based upon the digital signal. In contrast, prior art solutions attempting to characterize flicker have relied on implementations of complex algorithms to filters and extract information, which may require significant resources to implement. Such complex algorithms typical required substantial software overheads, and associated hardware resources, such as buffers and memory for storing data. Furthermore, due to the complexity of such algorithms, processing may be performed off-chip, further increasing overall system costs.

The processing circuitry may comprise a decimation filter. The decimation filter may be configured to filter the data output from the second or higher-order modulator.

The modulator may be a delta-sigma modulator.

The modulator may be single ended or differential.

The decimation filter may be a cascaded integrator comb (CIC) filter. The decimation filter may be third or higher order CIC.

Advantageously, the decimation filter may enable an improved signal-to-noise ratio and provide additional filtering and noise-shaping.

The radiation-sensitive device may be a photodiode. As such, the modulator may operate as a light-to-digital convertor.

A second or higher order modulator may enable improved sensitivity and faster conversion relative to implementations comprising a single integrator.

The processing circuitry may be configured to determine a frequency of the flicker in the incident radiation. The processing circuitry may be configured to determine a duty cycle of the flicker in the incident radiation.

Advantageously, by determining a frequency or duty cycle of the flicker in the incident radiation, an image-capturing device such as a camera may be adapted accordingly. For example, operation of an aperture may be synchronized to the determined flicker frequency to avoid banding effects as described above.

The processing circuitry may be configured to characterize flicker in the incident radiation as sinusoidal based, at least in part, upon detection of consecutive increments or decrements in the data.

For example, the processing circuitry may be configured detect at least one instance of a plurality of consecutive increments of the data, followed by a plurality of consecutive decrements of the data, or vice versa, and thus determine that the flicker is period and generally sinusoidal.

Advantageously, by determining that the flicker is sinusoidal, and particularly when such information is used on conjunction with a determined frequency, it may be inferred that the ambient light source flicker is derived from a mains power supply, e.g. a 50 Hz or 60 Hz alternating current power supply. Furthermore, with such determined information may be used to classify the ambient light source.

Furthermore, in some embodiments, the device may comprise one or more additional radiation-sensitive devices configured to determine spectral information related to the ambient light. Using a combination of spectral information, together with a determination that the flicker is sinusoidal and/or has a particular frequency, the ambient light source may be classified, e.g. as a tungsten incandescent light, a mercury-vapor lamp, or the like.

The processing circuitry may be configured to characterize flicker in the incident radiation as pulse-width-modulated based, at least in part, upon a rate of change of the data.

For example, the processing circuitry may be configured detect that a magnitude, e.g. an amplitude, of consecutive data changes by a predetermined factor. In some embodiments, the predetermined factor may be programmable.

Advantageously, by determining that the flicker is pulse-width-modulated, and particularly when such information is used on conjunction with a determined frequency, it may be inferred that the ambient light source flicker is of a particular type, e.g. an LED or the like. Following such a classification of a light source, an image-capturing device such as a camera may be configured accordingly to mitigate the impact of flicker upon any captured images.

The processing circuitry may be configured to determine a value corresponding to an amplitude modulation and/or frequency modulation of the flicker in the incident radiation.

For example, in some embodiments the processing circuitry may be configured to provide a value corresponding to a modulation percentage. The modulation percentage may correspond to a ratio between the minimum and maximum luminance during period of the flicker, e.g. a modulation of 100% would correspond to the light being completely turned on and off. In some embodiments, the processing circuitry may be configured to determine a flicker index.

Advantageously, determination of a value corresponding to an amplitude modulation and/or frequency modulation of the flicker in the incident radiation may enable an image-capturing device to be configured accordingly to mitigate possible effects of flicker in captured images.

The modulator may be configured to detect sinusoidal flicker having a frequency from 20 Hz to 20 kHz.

Advantageously, the provision of a second or higher order modulator may provide highly accurate detection with a high signal-to-noise ratio over a suitably broad frequency range to cover known ambient AC light sources. For example, fluorescent lights may have a flicker rate of 120 Hz, well within the range of capabilities of the disclosed device.

The modulator may be configured to detect pulse-width-modulated flicker having a frequency from 20 Hz to 20 kHz. The modulator may be configured to detect pulse-width-modulated flicker having a duty cycle between 5% and 95%.

Advantageously, the provision of a second or higher order modulator may provide capabilities of detecting flicker from a wide range of light sources.

The processing circuitry may be implemented as a state machine and/or digital logic.

Advantageously, the processing circuitry may be implemented completely in hardware, such that the characterization of flicker in the incident radiation requires no software.

The optical device may comprise at least one further radiation-sensitive device configured to function as at least one of: a spectral sensor; a proximity sensor; an image sensor; and/or an ambient light sensor.

For example, the optical device may comprise a plurality of radiation-sensitive devices, each device associated with a channel. The plurality of radiation-sensitive devices may be configured for spectral sensing. Each channel may be associated with detection of a particular range of wavelengths and/or polarity of radiation.

The optical device may comprise circuitry configured to automatically adapt a gain of an ADC coupled to the at least one further radiation-sensitive device, based upon the characterization of flicker in the incident radiation.

According to a second aspect of the disclosure, there is provided an apparatus comprising: an optical device according to the first aspect; and an LED display. The optical device may be disposed rearward of a radiation-emitting surface of the LED display and configured to receive radiation propagating through the LED display.

The apparatus may be one of: a smartphone; a cellular telephone; a tablet; or a laptop.

According to a third aspect of the disclosure, there is provided a system comprising: an optical device according to the first aspect; a camera; and a processor. The processor is configured to adapt an image taken by the camera and/or to configure the camera based upon the real-time characterization of flicker incident upon the optical device.

According to a fourth aspect of the disclosure, there is provided a method of characterizing flicker from an ambient light source. The method comprises configuring a second or higher-order modulator to provide data corresponding to a current from a radiation-sensitive device exposed to incident radiation. The method comprises configuring processing circuitry to analyze changes in the data to provide a real-time characterization of flicker in the incident radiation.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

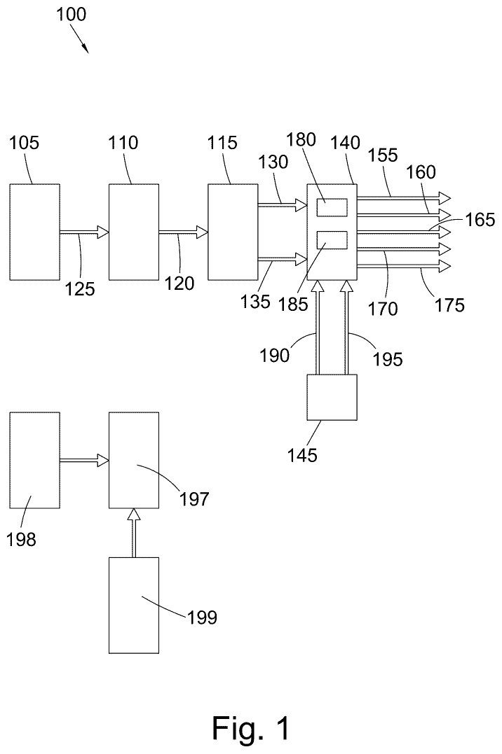

FIG. 1 depicts a block diagram of an optical device for characterizing flicker from an ambient light source, according to an embodiment of the disclosure;

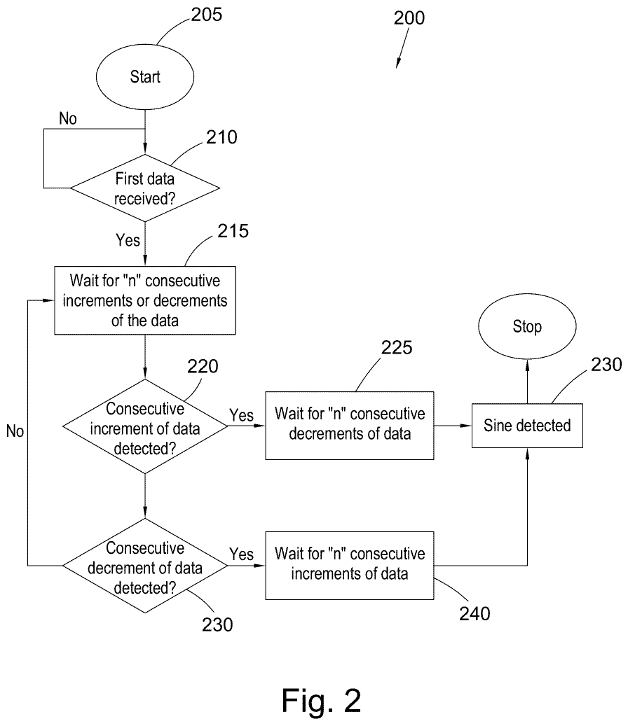

FIG. 2 depicts a flow-chart of a detection of sinusoidal flicker by the processing circuitry, in accordance with an embodiment of the disclosure;

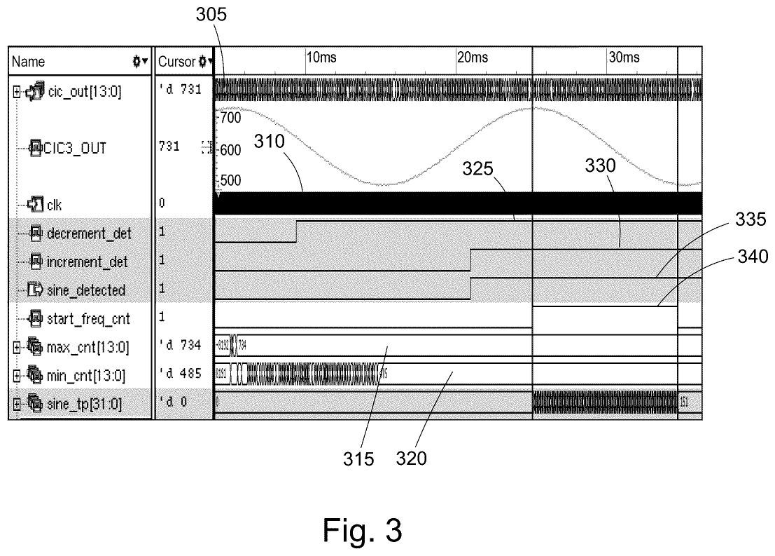

FIG. 3 depicts example of signals and waveforms from a simulation of characterization of sinusoidal flicker by the processing circuitry;

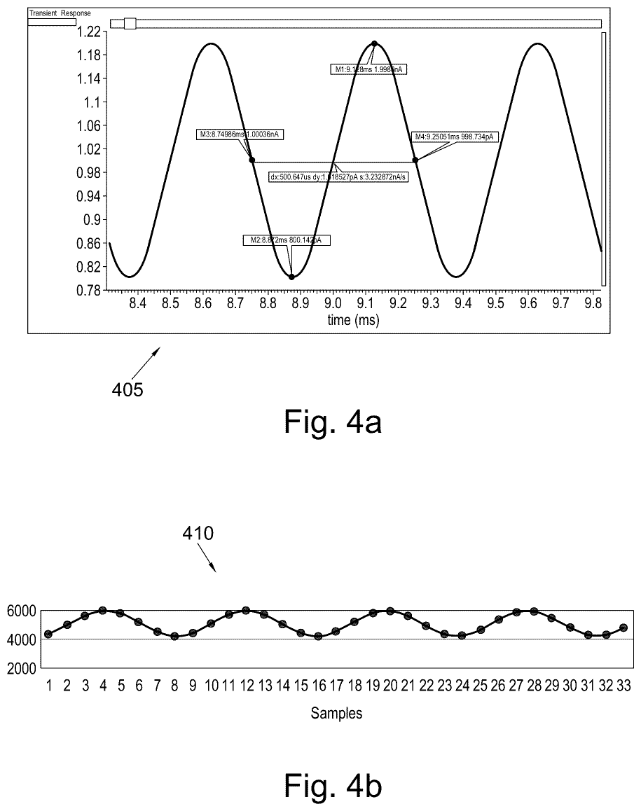

FIG. 4a depicts an example of a simulated sinusoidal input signal provided to a radiation-sensitive device;

FIG. 4b depicts an example of a simulated output from a modulator CIC output, in response to the input signal of FIG. 4a;

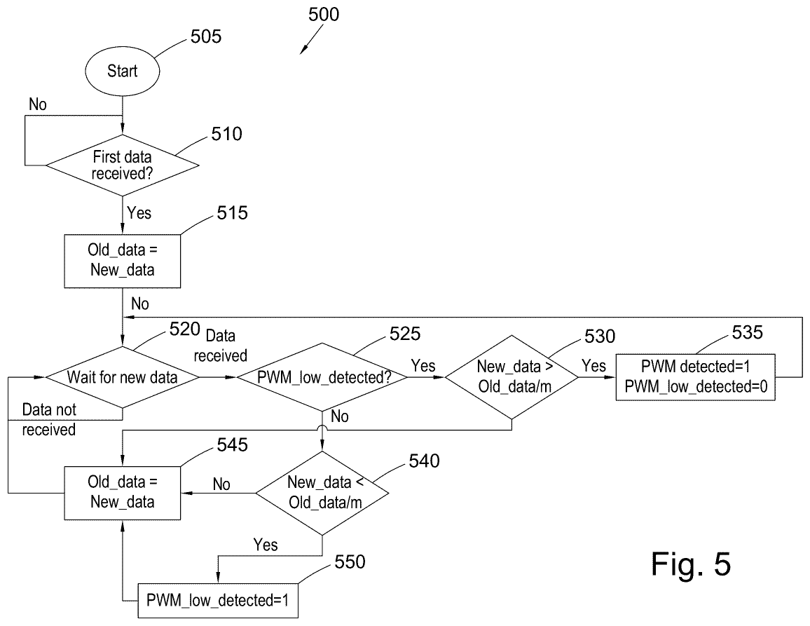

FIG. 5 depicts a flow-chart of a characterization of pulse-width-modulated flicker by the processing circuitry, in accordance with an embodiment of the disclosure;

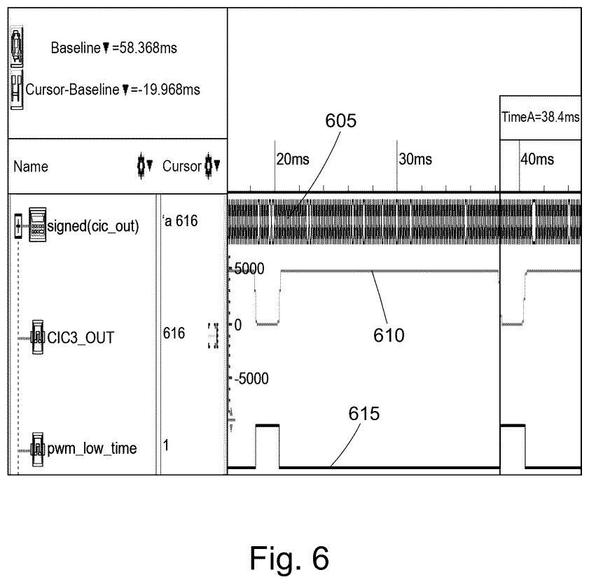

FIG. 6 depicts an example of signals and waveforms from a simulation of characterization of pulse-width modulated flicker by the processing circuitry;

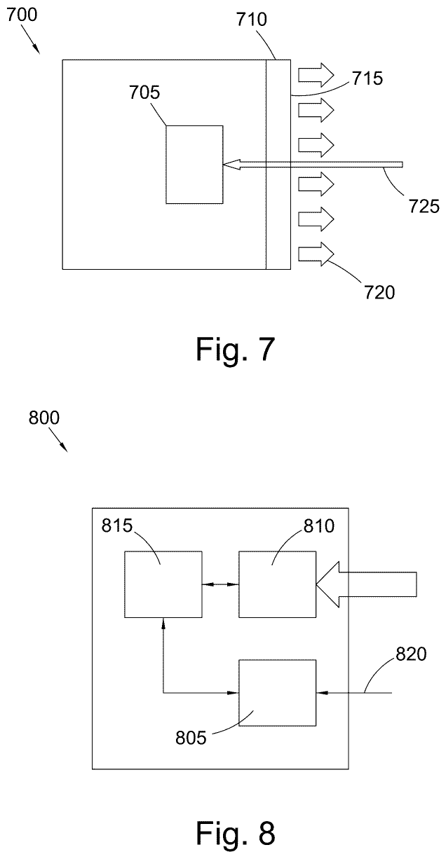

FIG. 7 depicts an apparatus comprising an optical device and an LED display according to an embodiment of the disclosure;

FIG. 8 depicts a system according to an embodiment of the disclosure; and

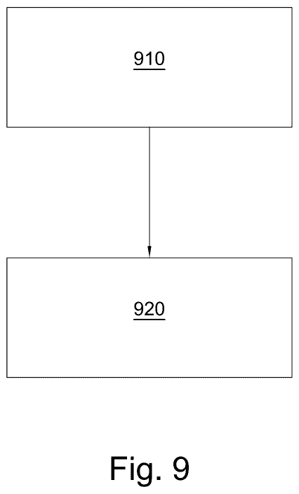

FIG. 9 depicts a method of characterizing flicker from an ambient light source according to an embodiment of the disclosure.

### DETAILED DESCRIPTION OF THE PREFERRED EMBODIMENTS

FIG. 1 depicts a block diagram of an optical device 100 for characterizing flicker from an ambient light source, according to an embodiment of the disclosure. The device 100 comprises a radiation-sensitive device 105 configured to vary a current in response to incident radiation. The radiation-sensitive device 105 may, for example, be a photodiode. In some embodiments, the radiation-sensitive device 105 may be configured to sense radiation having wavelength in the visible and/or infrared range. The radiation-sensitive device 105 may be configured to vary the current in response to an intensity of the incident radiation.

The device 100 also comprises a second order modulator 110. It will be appreciated that in other embodiments, the modulator may be of a higher order, e.g. a third order modulator or the like. Use of a second or higher order modulator may enable improved sensitivity and signal-to-noise ratios relative to implementations comprising a single integrator. The radiation-sensitive device 105 provides an input 125 to the second order modulator 110. In some embodiments, the input 125 corresponds to a current from the radiation-sensitive device 105. In some embodiments, a current of the input 125 varies in response to an intensity of the radiation incident upon the radiation-sensitive device 105.

As such, the second order modulator 110 together with the radiation-sensitive device 105 may operate as a light-to-digital convertor.

In some embodiments, second order modulator 110 may be a delta-sigma modulator. The second order modulator 110 may be single ended or differential.

The second order modulator 110 is configured to output data corresponding to the current from the radiation-sensitive device 105. In the example embodiment of FIG. 1, the second order modulator 110 outputs a bit-stream 120 corresponding to the current from the radiation-sensitive device 105. The bit-stream may be a 1-bit bit-stream.

The device 100 also comprises a decimation filter 115. The decimation filter 115 is configured to filter data in the bit-stream 120 from the second order modulator 110. In the example embodiment of FIG. 1, the decimation filter 115 is a cascaded integrator comb (CIC) filter. In some embodiments the decimation filter 115 may be a third or higher order CIC. The decimation filter 115 also effectively down-samples the bit-stream 120.

The decimation filter 115 provides an output signal 130. The output signal 130 may be a multi-bit signal, e.g. an N-bit signal. A precise number of bits will depend upon a particular implementation. For example, in one of the embodiments described in more detail below with reference to FIG. 3, an output from the decimation filter 115 has 14 bits, denoted “cic_out[13:0]”.

The decimation filter 115 also outputs an end-of-conversion signal 135. The end-of-conversion signal 135 may indicate when a sample is ready for processing, e.g. by processing circuitry 140 as described below. Similarly, the end-of-conversion signal 135 may also be used as a ‘busy’ signal, indicating to the processing circuitry 140 that sampling is in process.

The device 100 also comprises the processing circuitry 140. The processing circuitry 140 is configured to provide a real-time characterization of flicker in radiation incident upon the radiation sensitive device 105, based upon an analysis of changes in the data in the bit-stream 120 as described in more detail below. For example, the processing circuitry 140 may be configured detect at least one instance of a plurality of consecutive increments of the data, followed by a plurality of consecutive decrements of the data, or vice versa, and thus determine that the flicker is period and generally sinusoidal. In some embodiments, the processing circuitry 140 is implemented as a state machine and/or digital logic.

In the example embodiment of FIG. 1, the processing circuitry 140 is coupled to user configuration registers 145. The user configuration registers 145 may enable a user to provide parameters to the processing circuitry 140. In other embodiments, the processing circuitry 140 is coupled to a memory, wherein parameters may be read from the memory by the processing circuitry 140.

The processing circuitry 140 provides a plurality of output signals. The plurality of output signals comprise signals indicative of characteristics of flicker in radiation incident upon the radiation sensitive device 105. Each signal of the plurality of output signals may have one or more bits. In the example embodiment of FIG. 1, the plurality of output signals comprises:
a ‘pwm_detected’ signal 155 for indicating that a pulse-width modulated flicker signal has been detected;
a “pwm_frequency’ signal 160 for indicating a frequency of a detected pulse-width modulated flicker signal;
a ‘pwm_duty_cycle’ signal 165 for indicating a duty cycle of the detected pulse-width modulated flicker signal;
a ‘sine_detected’ signal 170 for indicating that a sinusoidal flicker signal has been detected; and
a ‘sine_frequency’ signal 175 for indicating a frequency of a sinusoidal flicker signal that has been detected.

It will be appreciated that in other embodiments, additional or alternative signals may be provided. For example, one or more signals may be provided for indicating a modulation percentage, or amplitude of a flicker signal that has been detected. Exampled of further signals are also provided below, with reference to FIG. 3.

In some embodiments, the processing circuitry 140 may comprises a plurality of counters. For example, the processing circuitry may comprise an increment counter 180 for storing a count corresponding to a number of consecutive increments in data in the output signal 130 of the digital decimation filter 115. Similarly, the processing circuitry may comprise a decrement counter 185 for storing a count corresponding to a number of consecutive decrements in data in the output signal 130 of the digital decimation filter 115.

Although the increment counter 180 and the decrement counter 185 are depicted as features of the processing circuitry 140 in FIG. 1, it will be appreciated that in other embodiments the increment counter 180 and the decrement counter 185 may be implemented in a memory or in registers accessible by the processing circuitry 140.

In some embodiments, the optical device 100 may comprise at least one further radiation-sensitive device 198 configured to function as at least one of: a spectral sensor; a proximity sensor; an image sensor; and/or an ambient light sensor.

For example, in some embodiments the optical device 100 may comprise a plurality of radiation-sensitive devices 198, each device associated with a channel. The plurality of radiation-sensitive devices 198 may be configured for spectral sensing. In some embodiments, each channel may be associated with detection of a particular range of wavelengths and/or polarity of radiation.

In some embodiments, the optical device 100 may comprise circuitry 199 configured to automatically adapt a gain of an ADC 197 coupled to the at least one further radiation-sensitive device, based upon determined characteristics of flicker in the incident radiation, e.g. based upon at least one of: the ‘pwm_detected’ signal 155; the “pwm_frequency’ signal 160; the ‘pwm_duty_cycle’ signal 165; the ‘sine_detected’ signal 170; and/or the ‘sine_frequency’ signal 175.

FIG. 2 depicts an example of a flow-chart 200 of a detection of sinusoidal flicker by the processing circuitry 140, in accordance with an embodiment of the disclosure.

At a starting point 205, the processing circuitry is configured to wait for data to be received from the output signal 130 of the digital decimation filter 115. At a first decision point 210, a determination is made as to whether a first data has been received. In some embodiments, the end-of-conversion signal 135 may indicate when a sample is ready for processing by the processing circuitry 140, and thus may indicate that the first data has been received.

When the first data has been received, the processing circuitry is configured to perform a process 215 of waiting for “n” consecutive increments or decrements of the data.

In some embodiments the parameter “n” is stored as a user programmable parameter. For example, the parameter “n” may be stored in the user configuration registers 145, or in a memory. In some embodiments, the parameter “n” has a default value of 2, or of 4. In some embodiments, the default value may be changed, or overwritten.

The parameter “n” may be provided to the processing circuitry 140 by a signal 190, as shown in FIG. 1.

At a second decision point 220, the processing circuitry is configured to determine whether there has been consecutive increments in the data from the output signal 130 of the digital decimation filter 115, e.g. whether a value of the data has consecutively increased over a plurality of measurements.

In some embodiments, when an increment in the data is detected, the decrement counter 185 is reset, e.g. cleared to a value of zero.

When consecutive increments of the first data have been detected, the processing circuitry 140 is configured to perform a process 225 of waiting for “n” consecutive increments. When “n” consecutive increments in the data have been detected, the processing circuitry 140 perform a process 230 of determining that a sinusoidal flicker signal has been detected, and asserts the ‘sine_detected’ signal 170.

At a third second decision point 220, the processing circuitry is configured to determine whether there has been consecutive decrements in the data from the output signal 130 of the digital decimation filter 115, e.g. whether a value of the data has consecutively decreased over a plurality of measurements.

In some embodiments, when a decrement in the data is detected, the increment counter 180 is reset, e.g. cleared to a value of zero.

When consecutive decrements of the first data have been detected, the processing circuitry 140 is configured to perform a process 240 of waiting for “n” consecutive decrements. When “n” consecutive decrements in the data have been detected, the processing circuitry 140 perform the process 230 of determining that a sinusoidal flicker signal has been detected, and asserts the ‘sine_detected’ signal 170.

FIG. 3 depicts example of signals and waveforms from a simulation of characterization of sinusoidal flicker by the processing circuitry 140. A first signal 305 corresponds to the output signal 130 from the decimation filter 115. In the example of FIG. 3, the output signal 130 from the decimation filter 115 is a 14-bit signal, denoted cic_out[13:0].

A first waveform 310 provides a graphical representation of the first signal 305, and can clearly be seen to represent a sinusoidal signal. Also shown is a second signal 315 corresponding to a maximum value of the output signal 130 from the decimation filter 115. In the example of FIG. 3, it can be seen that the first signal 305 representing the sinusoidal waveform has a peak value of 734. Similarly, also shown is a third signal 320 corresponding to a minimum value of the output signal 130 from the decimation filter 115. In the example of FIG. 3, it can be seen that the first signal 305 representing the sinusoidal waveform has a minimum value of 485. In some embodiments, the processing circuitry 140 may be configured to calculate a modulation coefficient and/or modulation percentage, based on the measured minimum and maximum values, e.g. peak and trough, of the sinusoidal waveform.

In the example of FIG. 3, it can be seen that between a time of approximately 5 ms and 9 ms, consecutive decrements in the data from the output signal 130 of the digital decimation filter 115 are detected. As such, the processing circuitry 140 is configured to assert a fourth signal 325 indicting that ‘n’ consecutive decrements have been detected, e.g. in accordance with process 235 as described with respect to FIG. 2.

It can also be seen that between a time of approximately 15 ms and 21 ms, consecutive increments in the data from the output signal 130 of the digital decimation filter 115 are detected. As such, the processing circuitry 140 is configured to assert a fifth signal 330 indicting that ‘n’ consecutive increments have been detected, e.g. in accordance with process 225 as described with respect to FIG. 2.

In this example embodiment, the processing circuitry is configured to determine that data from the output signal 130 of the digital decimation filter 115, e.g. first waveform 310, is sinusoidal based upon a determination of ‘n’ consecutive decrements followed by ‘n’ consecutive increments. Upon determining that the data corresponds to a sinusoidal signal, the processing circuitry 140 is configured to assert a fifth signal 335 indicating that a sinusoidal signal has been detected.

Furthermore, continuing with the example embodiment of FIG. 3, after determining that the data corresponds to a sinusoidal signal, e.g. after asserting the fifth signal 335, the processing circuitry 140 may be configured to determine a frequency of the sinusoidal signal.

For example, it can be seen that a sixth signal 340 is asserted at approximately time 25 ms, which corresponds to a peak of the sinusoidal waveform 310.

It can be seen that the sixth signal 340 is negated at approximately time 35 ms, which corresponds to a trough of the sinusoidal waveform 310. Thus, a total count between the peak and trough of the sinusoidal waveform 310 corresponds to a total time that the sixth signal 340 is asserted. In the example of FIG. 3, this corresponds to 10 ms, which is half of a period of the sinusoidal signal and therefore represents a sinusoidal waveform 310 having a frequency of 50 Hz.

As such, in some embodiments the processing circuitry 140 circuitry is configured to characterize flicker as being sinusoidal, and may be further configured to provided additional characteristics of the flicker such as amplitude, modulation percentage and frequency.

Thus, the processing circuitry 140 is configured to provide a real-time characterization of flicker in the incident radiation based upon an analysis of changes in the data from the output signal 130 of the digital decimation filter 115.

FIG. 4a depicts an example of a simulated sinusoidal input signal 405 provided to a radiation-sensitive device, e.g. the radiation-sensitive device 105. The sinusoidal input signal 405 has a period of 512 us, corresponding to a frequency of approximately 1.9 kHz.

FIG. 4b depicts an example of a simulated output 410 from a modulator CIC output, in response to the input signal of FIG. 4a. In an example embodiment, the second order modulator 110 samples every 1 us, e.g. has a sampling frequency of 1 MHz, and an over-sampling ratio (OSR) of 64. It can be seen that the simulated output corresponds to a sinusoidal waveform having a period corresponding to 8 samples. With an oversampling ratio of 64, and a sample rate of 1 microsecond, this corresponds to a sinusoidal waveform having a period of 64×8×1 us=512 us. Thus is can be seen that the decimator 115 significantly decreases an overall data rate, such that a data rate of the output signal 130 of the decimator for processing by the processing circuitry 140 is substantially lower that a data rate of the bit-stream 120 output by the second order modulator 110. In some embodiments, the modulator 110 may be configurable to detect sinusoidal flicker having a frequency from 20 Hz to 20 kHz. In some embodiments, a frequency of operation and/or the OSR may be programmable.

FIG. 5 depicts a flow-chart 500 of a characterization of pulse-width-modulated flicker by the processing circuitry 140, in accordance with an embodiment of the disclosure.

At a starting point 505, the processing circuitry 140 is configured to wait for new data to be received from the output signal 130 of the digital decimation filter 115. At a first decision point 510, a determination is made as to whether new data has been received. In some embodiments, the end-of-conversion signal 135 may indicate when a sample is ready for processing by the processing circuitry 140, and thus may indicate that the first data has been received.

When the new data has been received, the processing circuitry 140 is configured to perform a process 515 of updating a previously stored variable denoted ‘old_data’ with the new data, denoted ‘new_data’. At a second decision point 520, a determination is made by the processing circuitry 140 as to whether further data has been received from the output signal 130 of the digital decimation filter 115. When further data, hereafter denoted ‘new_data’ is received, the processing circuitry 140 progresses to a third decision point 525.

At the third decision point 525, a determination is made as to whether a parameter and/or signal denoted “PWM_low_detected” indicates that a low value of a PWM signal has been detected in a previous iteration. In some embodiments, “PWM_low_detected” may be a signal. In other embodiments, “PWM_low_detected” may correspond to a variable or parameter stored in a register or a memory.

If the signal denoted “PWM_low_detected” is negated, e.g. indicating that a low value of a PWM signal has not been detected in a previous iteration, then at a fourth decision point 540, ‘new_data’ data is compared to previously the received data, scaled by a parameter ‘m’. That is, the processor determines whether new_data<old_data/m. In some embodiments, the parameter m has a default value of 2, or of 4.

In some embodiments the parameter “m” is stored as a user programmable parameter. For example, the parameter “m” may be stored in the user configuration registers 145, or in a memory. In some embodiments, the parameter “m” has a default value of 2. In some embodiments, the default value may be changed, or overwritten.

The parameter “m” may be provided to the processing circuitry 140 by a signal 195, as shown in FIG. 1. The magnitude of the parameter m may determine a rate of change of the data that is determined by the processing circuitry 140 as corresponding to a transition between high and low phases of a PWM signal.

If new_data<old_data/m, then it may be determined by the processing circuitry 140 that a low value of a pulse width modulated signal is detected, and therefore the processing circuitry 140 asserts the signal denoted “PWM_low_detected”, e.g. sets PWM_low_detected=1 at process 550. After asserting the signal denoted “PWM_low_detected”, the processing circuitry is configured to perform a process 545 of updating the previously stored variable denoted ‘old_data’ with the further data denoted “new_data”. Next, the processing circuitry is configured to return to the second decision point 520 and thus wait for further data to be received from the output signal 130 of the digital decimation filter 115.

If at the third decision point 540 if is not determined that new_data<old_data/m, then the processing circuitry is configured to perform the process 545 of updating the previously stored variable denoted ‘old_data’ with the further data denoted “new_data”. After performing the process 545 of updating the previously stored variable denoted ‘old_data’ with the further data denoted “new_data”, the processing circuitry 140 is configured to return to the second decision point 520 and thus wait for further data to be received from the output signal 130 of the digital decimation filter 115.

If at the third decision point 525 it is determined that the signal denoted “PWM_low_detected” is asserted, e.g. indicating that a low value of a PWM signal has been detected in a previous iteration, then the processing circuitry 140 is configured to move to a fifth decision point 530.

At the fifth decision point, ‘new_data’ data is compared to previously the received data, scaled by the parameter ‘m’. That is, the processor determines whether new_data>old_data/m.

If new_data>old_data/m at the fifth decision point 530, then it may be determined by the processing circuitry 140 that a PWM signal is detected, and at a process 535 a parameter denoted “PWM_detected” is asserted, e.g. “PWM_detected=1”.

Also, if it is determined by the processing circuitry 140 that new_data>old_data/m at the fifth decision point 530, then it may also be determined by the processing circuitry 140 that a high value of a pulse width modulated signal is detected, and therefore at the process 535 the processing circuitry 140 negates the signal denoted “PWM_low_detected”, e.g. sets PWM_low_detected=0.

After performing the process 535, the processing circuitry 140 is configured to return to the second decision point 520 and thus wait for further data to be received from the output signal 130 of the digital decimation filter 115.

If at the fifth decision point 545 if is not determined that new_data>old_data/m, then the processing circuitry is configured to perform the process 545 of updating the previously stored variable denoted ‘old_data’ with the further data denoted “new_data”.

Again, after performing the process 545 of updating the previously stored variable denoted ‘old_data’ with the further data denoted “new_data”, the processing circuitry 140 is configured to return to the second decision point 520, and thus wait for further data to be received from the output signal 130 of the digital decimation filter 115.

As such, in some embodiments the processing circuitry 140 is configured to characterize flicker as being pulse width modulated, and determine when the PWM signal is high or low. In some embodiments, having determined when a PWM signal transitions from high to low or low to high as described above, the processing circuitry 140 may be further configured to determine a frequency and/or duty cycle of the PWM signal. For example, the frequency of the PWM signal may be determined by the processing circuitry 140 from a time between consecutive rising/falling edges of the PWM_low_detected signal. The processing circuitry 140 may be configured to determine a duty cycle of the PWM signal from a time between a rising edge and a falling edge of the PWM_low_detected signal. In some embodiments the modulator 110 may be configured to detect pulse-width-modulated flicker having a frequency from 20 Hz to 20 kHz and/or a duty cycle of between 5% and 95%.

FIG. 6 depicts an example of signals and waveforms from a simulation of characterization of pulse-width modulated flicker by the processing circuitry 140. In the example of FIG. 6, a first signal 605 corresponds to the output signal 130 from the decimation filter 115, and is denoted “signed(cic_out)”. A first waveform 610 provides a graphical representation of the first signal 605, and can clearly be seen to represent a pulse width modulated signal. Also shown is a second signal 615 denoted “pwm_low_time”, which corresponds to the above-described “PWM_low_detected” signal. Thus, it can be seen that in embodiments of the disclosure, the processing circuitry 140 may be configured to provide the signal second signal 615 that closely corresponds to a sampled PWM signal, thereby enabling a subsequent determination of a frequency and duty cycle of the PWM signal as described above.

FIG. 7 depicts an apparatus 700 comprising an optical device 705 and an LED display 710 according to an embodiment of the disclosure. The optical device 705 is an optical device 100 as described above.

In the example embodiment of FIG. 7, the optical device 705 is disposed rearward of a radiation-emitting surface 715 of the LED display 710. The radiation-emitting surface 715 is configured to emit radiation 720. In embodiments of the disclosure, the apparatus 700 may be, for example, a smartphone, a cellular telephone, a tablet, a laptop, or a communications device.

The optical device 705 is configured to receive radiation 725 propagating through the LED display 710. In some embodiments, the LED display 710 may be an organic LED (OLED) display 710.

In some embodiments, the optical device 705 may comprise one or more filters, polarizers or optical element such as lenses disposed formed on or otherwise coupled to a radiation-sensitive device of the optical device 705.

As such, FIG. 7 depicts an apparatus 700 wherein the optical device 705 may be configured to characterise flicker in ambient light that has propagated through a display 710 of the apparatus.

FIG. 8 depicts a system 800 according to an embodiment of the disclosure. The system 800 comprises an optical device 805. The optical device 805 is an optical device 100 as described above.

The system 800 also comprises a camera 810 and a processor 815. The optical device 805 is coupled to the processor 815. The camera 810 is coupled to the processor 815. The processor 815 is configured to adapt an image taken by the camera 810 and/or to configure the camera 810 based upon the real-time characterization of flicker in radiation 820 incident upon the optical device 805. That is, in some embodiments the optical device 805 is configured to characterize flicker, as described above with reference to the above embodiments of the optical device 100. Information pertaining to the characterization, such as modulation type, modulation percentage, frequency and/or duty cycle information, may subsequently be used by the processor 815 to adapt an image taken by the camera 810 and/or to configure the camera 810, e.g. to adjust settings of the camera 810 to improve a quality of an image captured by the camera 810.

FIG. 9 depicts a method of characterizing flicker from an ambient light source. The method comprises a first step 910 of configuring a second or higher-order modulator 110 to provide data corresponding to a current from a radiation-sensitive device 105 exposed to incident radiation.

The method also comprises a second step 920 of configuring processing circuitry 140 to analyze changes in the data to provide a real-time characterization of flicker in the incident radiation.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

LIST OF REFERENCE NUMERALS

| | |
|---|---|
| 100 | optical device |
| 105 | radiation-sensitive device |
| 110 | second order modulator |
| 115 | decimation filter |
| 120 | bit-stream |
| 125 | input |
| 130 | output signal |
| 135 | end-of-conversion signal |
| 140 | processing circuitry |
| 145 | user configuration registers |
| 155 | pwm_detected signal |
| 160 | pwm_frequency signal |
| 165 | pwm_duty_cycle signal |
| 170 | sine_detected signal |
| 175 | sine_frequency signal |
| 180 | increment counter |
| 185 | decrement counter |
| 190 | signal |
| 195 | signal |
| 197 | ADC |
| 198 | radiation-sensitive device |
| 199 | circuitry |
| 200 | flow-chart |
| 205 | starting point |
| 210 | first decision point |
| 215 | process |
| 220 | second decision point |
| 225 | process |
| 230 | process |
| 235 | process |
| 240 | process |
| 305 | first signal |
| 310 | first waveform |
| 315 | second signal |
| 320 | third signal |
| 325 | fourth signal |
| 330 | fifth signal |
| 340 | sixth signal |
| 405 | input signal |
| 410 | output |
| 500 | flow-chart |
| 505 | starting point |
| 510 | first decision point |
| 515 | process |
| 520 | second decision point |
| 525 | third decision point |
| 530 | fifth decision point |
| 535 | process |
| 540 | fourth decision point |
| 545 | process |
| 550 | process |
| 605 | first signal |
| 610 | first waveform |
| 615 | second signal |
| 700 | apparatus |
| 705 | optical device |
| 710 | LED display |
| 715 | radiation-emitting surface |
| 720 | radiation |
| 725 | radiation |
| 800 | system |
| 805 | optical device |
| 810 | camera |
| 815 | processor |
| 910 | first step |
| 920 | second step |

1. An optical device for characterizing flicker from an ambient light source, the device comprising:
a radiation-sensitive device configured to vary a current in response to incident radiation;
a second or higher-order modulator configured to output data corresponding to the current; and
processing circuitry configured to provide a real-time characterization of flicker in the incident radiation based upon an analysis of changes in the data.

2. The optical device of claim 1, wherein the processing circuitry comprises a decimation filter configured to filter the data output from the second or higher-order modulator.

3. The optical device of claim 1, wherein the processing circuitry is configured to determine a frequency and/or duty cycle of the flicker in the incident radiation.

4. The optical device of claim 1, wherein the processing circuitry is configured to characterize flicker in the incident radiation as sinusoidal based, at least in part, upon detection of consecutive increments or decrements in the data.

5. The optical device of claim 1, wherein the processing circuitry is configured to characterize flicker in the incident radiation as pulse-width-modulated based, at least in part, upon a rate of change of the data.

6. The optical device of claim 1, wherein the processing circuitry is configured to determine a value corresponding to an amplitude modulation and/or frequency modulation of the flicker in the incident radiation.

7. The optical device of claim 1, wherein the modulator is configured to detect sinusoidal flicker having a frequency from 20 Hz to 20 kHz.

8. The optical device of claim 1, wherein the modulator is configured to detect pulse-width-modulated flicker having a frequency from 20 Hz to 20 kHz and a duty cycle between 5% and 95%.

9. The optical device of claim 1, wherein the processing circuitry is implemented as a state machine and/or digital logic.

10. The optical device of claim 1, comprising at least one further radiation-sensitive device configured to function as at least one of:
a spectral sensor;
a proximity sensor;
an image sensor; and/or
an ambient light sensor.

11. The optical device of claim 10, comprising circuitry configured to automatically adapt a gain of an ADC coupled to the at least one further radiation-sensitive device, based upon the characterization of flicker in the incident radiation.

12. An apparatus comprising:
an optical device according to; and
an LED display;
wherein the optical device is disposed rearward of a radiation-emitting surface of the LED display and configured to receive radiation propagating through the LED display.

13. The apparatus of claim 12, wherein the apparatus is one of:
a smartphone;
a cellular telephone;
a tablet; or
a laptop.

14. A system comprising:
an optical device according to claim 11;
a camera; and
a processor;
wherein the processor is configured to adapt an image taken by the camera and/or configure the camera based upon the real-time characterization of flicker incident upon the optical device.

15. A method of characterizing flicker from an ambient light source, the method comprising
configuring a second or higher-order modulator to provide data corresponding to a current from a radiation-sensitive device exposed to incident radiation; and
configuring processing circuitry to analyze changes in the data to provide a real-time characterization of flicker in the incident radiation.
